(19) United States
(12) Patent Application Publication
(10) Pub. No.: US 2026/0270029 A1
(43) Pub. Date: Sep. 10, 2026

(54) TRIGGER CONDITIONS FOR EVENT-DRIVEN UE BEAM REPORTING

(71) Applicant: Telefonaktiebolaget LM Ericsson (publ), Stockholm (SE)

(72) Inventors: Claes Tidestav, Bålsta (SE); Siva Muruganathan, Stittsville (CA); Icaro Leonardo Da Silva, Solna (SE); Daniele Davoli, Stockholm (SE); Pradeepa Ramachandra, Linköping (SE); Andreas Nilsson, Göteborg (SE)

(21) Appl. No.: 19/102,131

(22) PCT Filed: Aug. 9, 2023
(86) PCT No.: PCT/IB2023/058070

§ 371 Date: Feb. 7, 2025

Related U.S. Application Data
(60) Provisional application No. 63/396,510, filed on Aug. 9, 2022.

(51) Int. Cl. H04L 5/00; H04B 7/06; H04W 72/044; H04W 72/542

(52) U.S. Cl. CPC H04L 5/0094; H04B 7/06958; H04L 5/0098; H04W 72/046; H04W 72/542

(57) ABSTRACT

Systems and methods for trigger conditions for event-driven User Equipment (UE) beam reporting are provided. In some embodiments, a method performed by a UE includes: receiving a configuration of a plurality of Downlink (DL) reference signals which represent a plurality of candidate links; receiving a beam indication where a first DL reference signal is used as the Quasi-Colocation (QCL) source for the demodulation reference signal (DMRS) of the serving link; measuring a quality of the serving link; measuring a quality of the candidate links; if the quality of the serving link is worse than the candidate links: transmitting an event-triggered beam report; and receiving a beam update. This might enable an accurate calculation of the quality of the link serving the UE, and events with that quality as input will be triggered when a better link is found.

### RELATED APPLICATIONS

This application claims the benefit of provisional patent application Ser. No. 63/396,510, filed Aug. 9, 2022, the disclosure of which is hereby incorporated herein by reference in its entirety.

### TECHNICAL FIELD

The present disclosure relates generally to beam reporting.

### BACKGROUND

### QCL and TCI States

In NR, several signals can be transmitted from different antenna ports of the same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target reference signal (RS) were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to receive also this signal. Note that for beam management, the discussion mostly revolves around QCL Type D, but it is also necessary to convey a Type A QCL relation for the RSs to the UE, so that it can estimate all the relevant large-scale parameters.

Typically, this is achieved by configuring the UE with a CSI-RS for tracking (TRS) for time/frequency offset estimation. To be able to use any QCL reference, the UE would have to receive it with a sufficiently good SINR. In many cases, this means that the TRS must be transmitted in a suitable beam to a certain UE.

To introduce dynamics in beam and transmission point (TRP) selection, the UE can be configured through RRC signaling with up to 128 Transmission Configuration Indicator (TCI) states. The TCI state information element is shown below and in FIG. 1 (TCI State information element (Extracted from 3GPP TS 38.331)).

| | |
|---|---|
| TCI-State ::= | SEQUENCE { |
| tci-StateId | TCI-StateId, |
| qcl-Type1 | QCL-Info, |
| qcl-Type2 | QCL-Info, |
| ... | |
| } | |
| QCL-Info ::= | SEQUENCE { |
| cell | ServCellIndex |
| bwp-Id | BWP-Id |
| referenceSignal | CHOICE { |
| csi-rs | NZP-CSI-RS-ResourceId, |
| ssb | SSB-Index |
| }, | |
| qcl-Type | ENUMERATED |
| | {typeA, typeB, typeC, typeD}, |
| ... | |
| } | |

Each TCI state contains QCL information related to one or two RSs. For example, a TCI state may contain CSI-RS1 associated with QCL Type A and CSI-RS2 associated with QCL TypeD. If a third RS, e.g., the PDCCH DMRS, has this TCI state as QCL source, it means that the UE can derive Doppler shift, Doppler spread, average delay, delay spread from CSI-RS1 and Spatial Rx parameter (i.e., the RX beam to use) from CSI-RS2 when performing the channel estimation for the PDCCH DMRS.

A first list of available TCI states is configured for PDSCH, and a second list of TCI states is configured for PDCCH. Each TCI state contains a pointer, known as TCI State ID, which points to the TCI state. The network then activates via MAC CE one TCI state for PDCCH (i.e., provides a TCI for PDCCH) and up to eight TCI states for PDSCH. The number of active TCI states the UE support is a UE capability, but the maximum is 8.

Assume a UE has four activated TCI states (from a list of totally 64 configured TCI states). Hence, 60 TCI states are inactive for this particular UE and the UE needs not be prepared to have large scale parameters estimated for those inactive TCI states. But the UE continuously tracks and updates the large-scale parameters for the RSs in the four active TCI states. When scheduling a PDSCH to a UE, the DCI contains a pointer to one activated TCI state. The UE then knows which large-scale parameter estimate to use when performing PDSCH DMRS channel estimation and thus PDSCH demodulation.

As long as the UE can use any of the currently activated TCI states, it is sufficient to use DCI signaling. However, at some point in time, none of the source RSs in the currently activated TCI states can be received by the UE, i.e., when the UE moves out of the beams in which the source RSs in the activated TCI states are transmitted. When this happens (or actually before this happens), the gNB would have to activate new TCI states. Typically, since the number of activated TCI states is fixed, the gNB would also have to deactivate one or more of the currently activated TCI states.

The two-step procedure related to TCI state update is depicted in FIG. 2. FIG. 2 illustrates a two-stage TCI state update. The selected TCI state is selected from the activated set of TCI states using DCI, and the set of activated TCI states is updated using MAC CE.

### TCI States Activation/Deactivation for UE-Specific PDSCH Via MAC CE

Details of the MAC CE signaling that is used to activate/deactivate TCI states for UE specific PDSCH are provided. The structure of the MAC CE for activating/deactivating TCI states for UE specific PDSCH is given in FIG. 3. FIG. 3 illustrates TCI States Activation/Deactivation for UE-specific PDSCH MAC CE (Extracted from FIG. 6.1.3.14-1 of 3GPP TS 38.321).

As shown in FIG. 3, the MAC CE contains the following fields:
Serving Cell ID: This field indicates the identity of the Serving Cell for which the MAC CE applies. The length of the field is five bits;
BWP ID: This field contains the ID corresponding to a downlink bandwidth part for which the MAC CE applies. The BWP ID is given by the higher layer parameter BWP-Id as specified in 3GPP TS 38.331. The length of the BWP ID field is two bits since a UE can be configured with up to four BWPs for DL;
A variable number of fields Tᵢ: If the UE is configured with a TCI state with TCI State ID i, then the field Tᵢ indicates the activation/deactivation status of the TCI state with TCI State ID i. If the UE is not configured with a TCI state with TCI State ID i, the MAC entity shall ignore the Tᵢ field. The Tᵢ field is set to “1” to indicate that the TCI state with TCI State ID i shall be activated and mapped to a codepoint of the DCI Transmission Configuration Indication field, as specified in 3GPP TS 38.214/38.321. The Tᵢ field is set to “0” to indicate that the TCI state with TCI State ID i shall be deactivated and is not mapped to any codepoint of the DCI Transmission Configuration Indication field. It should be noted that the codepoint to which the TCI State is mapped is determined by the ordinal position among all the TCI States with Tᵢ field set to “1”. That is the first TCI State with Tᵢ field set to “1” shall be mapped to the codepoint value 0 of DCI Transmission Configuration Indication field, the second TCI State with Tᵢ field set to “1” shall be mapped to the codepoint value 1 of DCI Transmission Configuration Indication field, and so on. In NR Rel-15, the maximum number of activated TCI states is 8;
A Reserved bit R: this bit is set to ‘0’ in NR Rel-15.

Note that the TCI States Activation/Deactivation for UE-specific PDSCH MAC CE is identified by a MAC PDU subheader with logical channel ID (LCID) as specified in Table 6.2.1-1 of 3GPP TS 38.321 (this table is reproduced below in Table 1). The MAC CE for Activation/Deactivation of TCI States for UE-specific PDSCH has variable size.

### TCI State Indication for UE-Specific PDSCH Via DCI

The gNB can use DCI format 1_1 or 1_2 to indicate to the UE that it shall use one of the activated TCI states for the subsequent PDSCH reception. The field being used in the DCI is Transmission configuration indication, which is 3 bits if tci-PresentInDCI is “enabled” or tci-PresentForDCI-Format1-2-r16 is present respectively for DCI format 1_1 and DCI 1_2 by higher layer. One example of such a DCI indication is depicted in FIG. 4 which illustrates an example of DCI indication of a TCI state. The DCI gives a pointer into the ordered list of activated TCI states.

DCI code point 0 indicates the first TCI state index in the list of TCI states, DCI code point 1 indicates the second TCI state index in the list, and so on.

### Overview of NR Rel-15/Rel-16 TCI State Framework

The NR Rel-15/16 framework for beam management is based on the framework of spatial QCL assumptions and spatial relations in order to support, e.g., analog beamforming implementations at the UE and/or the network. The framework allows great flexibility for the network (i.e., the gNB) to instruct the UE to receive signals from several directions and to transmit signals in several directions. In this framework, the uplink and downlink configurations are decoupled, e.g., there is no direct relation between the configured spatial QCL assumptions and the spatial relations.

In the Rel-15/Rel-16 framework, downlink beam management is performed by conveying spatial QCL (‘Type D’) assumptions to the UE, which are conveyed in TCI states. One TCI state contains one or two RSs, and each RS is associated with a QCL type.
PDCCH beam management: The network configures the UE with a set of PDCCH TCI states by RRC, and then activates one TCI state per CORESET using MAC CE.
PDSCH beam management: The network configures the UE with a set of PDSCH TCI states by RRC, and then activates up to 8 TCI states by MAC CE. After activation, the network dynamically indicates one of these activated TCI states using a TCI field in DCI when scheduling PDSCH.
   Alternatively, the network may simplify the beam management by not setting the RRC parameter tci-PresentInDCI (which is configured per CORESET) to enabled. In this case, the UE uses the same TCI state for PDSCH as for PDCCH.

In the Rel-15/Rel-16 framework, uplink beam management is performed using configuration of spatial relations. A spatial relation is defined at the UE side between a source RS and a target RS. The source RS can be a received DL RS (SSB or CSI-RS) or an SRS. The target RS can be a transmitted PUCCH DMRS or an SRS. Note that there is no direct configuration of the spatial relation for a PUSCH: the PUSCH follows the spatial relation of a PUCCH or an SRS.
PUCCH beam management: For PUCCH, the network configures the UE with a set of 8 spatial relations using RRC, and subsequently activates one of these spatial relations using MAC CE. The spatial relation is defined per PUCCH resource. In Rel-16, enhancements were made such that spatial relation could be updated for a group of PUCCH resources using a single MAC-CE. In addition, default spatial relation for PUCCH was introduced in Rel-16, such that when no spatial relation is configured/activated for a PUCCH resource, the UE uses the TCI state/QCL assumption of the CORESET with lowest ID, both to derive spatial relation and to derive path loss reference signal.
PUSCH beam management: A PUSCH scheduled by DCI Format 0_1 is transmitted over the ports where a configured SRS resource may also be transmitted. Either two (codebook-based) or four (non-codebook-based) SRS resources can be defined in the SRS resource set. The network selects which SRS resource in the set should correspond to the PUSCH transmission (i.e., PUSCH is transmitted on the same ports as the selected SRS and using the spatial relation of the selected SRS) using the SRS resource indicator (SRI) field in DCI. The spatial relation for the SRS resources in the set is provided either by RRC (for periodic or aperiodic SRS) or MAC-CE (for aperiodic or semi-persistent SRS). For PUSCH scheduled by DCI Format 0_0, there is no SRI and the spatial relation instead follows that of a PUCCH resource. In Rel-16, default spatial relation for SRS was introduced, such that when no spatial relation is configured/activated for an SRS resource, the UE uses the TCI state/QCL assumption of the CORESET with lowest ID, both to derive spatial relation and to derive path loss reference signal.
SRS beam management: Spatial relations for SRS are configured by RRC (for periodic and aperiodic) or by MAC CE (aperiodic or semi-persistent)
   Issues with the Rel-15/Rel-16 TCI State Framework

The Rel-15/Rel-16 framework provides the NW with great flexibility in some areas, at the cost of quite some signalling. In some other areas, the specification is overly restrictive and prohibits efficient (low signalling overhead) and rapid beam management. These limitations are particularly noticeable and costly when UE movement is considered. One example is that beam update using DCI can only be performed for PDSCH, and MAC-CE and/or RRC is required to update the beam for other reference signals/channels, with cause extra overhead and latency.

Furthermore, in many cases, the specified beam management flexibility is not really needed since the network will transmit to and receive from the UE using the same beam for both data and control. Hence, using TCI state for DL signals/channels and spatial relations for UL signals/channels complicates the implementations.

Another issue is related to the path loss reference signal used for UL power control. In NR, only up to four path loss reference signals can be configured for a UE, which typically is significantly less than the number of beams a TRP at FR2 uses to cover the cell. Hence, when a UE moves around in the cell, the path loss reference signal needs to be updated using MAC-CE and/or RRC, which introduces extra latency and overhead.

### Rel-17 TCI State Framework

In 3GPP Rel-17, a new unified TCI state framework is specified, which aims to streamline the indication of transmit/receive spatial filter (and other QCL properties) to the UE by letting a single TCI state indicate QCL properties for multiple different DL and/or UL signals/channels.

The unified TCI state framework of Rel-17 can be RRC configured in one out of two modes of operation “Joint DL/UL TCI” or “Separate DL/UL TCI”. For “Joint DL/UL TCI” operation, one common Joint TCI state is used for both DL and UL signals/channels. For “Separate DL/UL TCI” operation, one common DL-only TCI state is used for DL channels/signals, and one common UL-only TCI state is used for UL signals/channels.

It is expected that “Joint DL/UL TCI” operation will be the most common use case, but “Separate DL/UL TCI” operation can be useful in specific scenarios where the optimal DL beam differs from optimal UL beam, for example in case a UE panel associated with the best DL beam is affected by P-MPR (power management−maximum power reduction), and hence need to reduce the maximum allowed output power.

### Beam Indication Using Rel-17 TCI State Framework

The common TCI state ID can be updated in a similar way as the TCI state ID is update for PDSCH in Rel-15/16, i.e., with one of two alternative:
Two-stage: RRC signaling is used to configure a number TCI states in PDSCH-config, and MAC-CE is used to activate a single TCI state (that TCI state will then be applied)
Three-stage: RRC signaling is used to configure a number TCI state in PDSCH-config, MAC-CE is used to activate up to 8 TCI states, and a 3-bit TCI state bitfield (consisting of up to 8 codepoints) in DCI is used to indicate one of the activate TCI states (that TCI state will then be applied)

For “Joint DL/UL TCI” operation, maximum one Joint TCI state can be activated per TCI codepoint. One schematic example of how this may look is illustrated in FIG. 5 which illustrates an example of activated TCI states and their mapping to TCI field codepoints for “Joint DL/UL TCI”. In case the indicated TCI codepoint is “0”, the UE should apply “Joint TCI state 7” as common QCL source for both DL and UL signals/channels.

For “Separate DL/UL TCI” operation, up to two TCI states can be activated per TCI codepoint, one for DL signals/channels (DL-only TCI state) and one for UL signals/channels (UL-only TCI state). One schematic example of how this may look is illustrated in FIG. 6 which illustrates an example of activated TCI states and their mapping to TCI field codepoints for “Joint DL/UL TCI”. In case the TCI codepoint is “0”, the UE should apply “DL-only TCI state 3” as common QCL source for DL signals/channels, and not update the QCL source for UL signals channel. In case the TCI codepoint is “7”, the UE should apply “UL-only TCI state 57” as QCL source for UL signals/channels, and not update the QCL source for DL signals/channel. In case the TCI codepoint is “3”, the UE should apply “DL-only TCI state 9” as QCL source for DL signals/channels and apply “UL-only TCI state 1” as QCL source for UL signals/channels.

The existing DCI formats 1_1 and 1_2 in NR are reused (as in Rel-15/16 beam management framework) for beam indication, both with and without DL assignment. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS PDSCH release with both type-1 and type-2 HARQ-ACK codebook is used, where upon a successful reception of the beam indication DCI, the UE reports an ACK.

For DCI-based beam indication, the first slot to apply the indicated TCI state is at least Y symbols after the last symbol of the acknowledgment of the joint or separate DL/UL beam indication. The Y symbols are configured by the gNB based on UE capability, which is also reported in units of symbols.

### QCL and UL Spatial Relation Rules

For both “Joint DL/UL TCI” operation and “Separate DL/UL TCI” operation, the large scale QCL properties are inferred from one source RS (qcl-Type1 only) or two source RSs (qcl-Type1 and qcl-Type2) analogous to Rel-15/16 beam management framework. For “Joint DL/UL TCI” operation, the UL spatial filter is derived from that corresponding to the source RS of DL QCL Type D, analogous to default beam operation for Rel-15/16 beam management framework.

In DL, the Joint/DL-only TCI state can provide common QCL information at least for
UE-dedicated PDCCH
PDSCH
Aperiodic CSI-RS for CSI
Aperiodic CSI-RS for beam management
   CSI-RS for other time domain behaviors has not been agreed

RRC configuration is used to indicate if a non-UE dedicated PDCCH/PDSCH, AP CSI-RS for CSI and BM should follow the common beam or not. Common beam here means that the same beam is used for receiving DL signals/channels that are indicated to follow the common beam. For DL signal/channels that do not follow the common beam, a Rel-17 TCI state can be indicated as QCL source in a similar way as for Rel-15/16 beam management framework. As an example, for a periodic CSI-RS that does not follow the common beam, a Rel-17 TCI state can be configured in the parameter “qcl-InfoPeriodicCSI-RS” in “NZP-CSI-RS-Resource information element” as specified in 3GPP TS 38.331 V16.7.0. The possible target and source RS and corresponding QCL properties for that are supported for Joint/DL-only TCI state indication are summarized in Table 1.

TABLE 1
Possible configurations of target and source RS and corresponding
QCL properties for Joint/DL-only TCI state indication

| Source RS (*) | Target RS | QCL Type(s) |
|---|---|---|
| SSB | Periodic TRS | C + D or C |
| | CSI-RS for BM | C + D or C |
| | CSI-RS for CSI | A + D or A |
| Periodic TRS | AP TRS | A + D or A |
| | CSI-RS for BM | A + D or A |
| | CSI-RS for CSI | A + D or A or B |
| | PDCCH/PDSCH DMRS | A + D or A |
| CSI-RS for BM | Periodic TRS | D |
| | CSI-RS for BM | D |
| | CSI-RS for CSI | D |
| | PDCCH/PDSCH DMRS | D |
| CSI-RS for CSI | PDCCH/PDSCH DMRS | A + D |

In UL, the Joint/UL-only TCI state can provide common QCL information as least for:
All or a subset of all PUCCH resources
Dynamic-grant/configured-grant PUSCH
SRS for all usages (except for usage ‘positioning’)

RRC configuration is used to indicate if a SRS and PUCCH resource should follow the common beam or not. Common beam here means that the same beam is used for receiving UL signals/channels that are indicated to follow the common beam. For UL signal/channels that do not follow the common beam, a Rel-17 TCI state can be used to indicate spatial relation instead of a DL/UL-RS which is used to indicate spatial relation for Rel-15/16 beam management framework. As an example, for a periodic SRS resource that does not follow the common beam, a new RRC parameter in an SRS resource can be configured with a Rel-17 TCI state, and the UE will use that Rel-17 TCI state to determine the spatial relation for that SRS resource. Any of the following reference signals can be used to indicate spatial relation for a UL signal/channel in Rel-17 TCI state framework:
SSB
TRS (tracking reference signal)
CSI-RS for beam management
SRS with usage set to beam management

### Inter-Cell Beam Management

Inter-cell beam management has been included in the Rel-17 TCI state framework to facilitate L1/L2 inter-cell mobility (to be specified for higher layers in NR Rel-18) as well as inter-cell multi-TRP operation.

For inter-cell beam management, a UE can be configured to measure and report Rel-15 L1-RSRP for SSB(s) associated with non-serving cells. Which serving cell an SSB is associated with is indicated by RRC signaling, where each SSB is paired with a PCI. The maximum number of PCIs different from the serving cell that could be used for SSB measurement/reporting is up to UE capability and can be one of 0, 1, 2, 3, and 7. The beam indication for inter-cell beam management will work in the same way as for intra-cell Rel-17 unified TCI state framework, as described herein.

The DL QCL and UL spatial relation rules for inter-cell beam management will work in the same way as for intra-cell Rel-17 unified TCI state framework, as described herein.

### Mobility Measurements in LTE and NR

The UE can be configured by the network to perform measurements of serving and neighbor cells, by sending a measurement configuration, provided in an RRCReconfiguration message (in case of NR) or an RRCConnectionReconfiguration RRC message (for LTE), or as part of broadcasted system information. In accordance with this measurement configuration provided by the network, the UE also reports measurement information, using a Measurement Report RRC message, to the network. The network then typically uses the measurement reports to trigger handover of the UE to a neighbor cell.

The neighbor cell measurements are classified into intra-frequency, inter-frequency or inter-RAT measurements.

The UE measures on what is defined as a measurement object, which is part of the measurement configuration. A measurement object is:
for LTE: a carrier frequency
for NR: frequency/time location and subcarrier spacing of reference signals.

The measurement object may be refined by listed cells (such as allowed cells, and/or excluded cells) as well as listed cell-specific offsets. Excluded (also called blacklisted cells) are not considered in event evaluation or measurement reporting. The allowed (also called whitelisted) cells may be the only ones considered for event evaluation and measurement reporting if so configured. If neither allowed nor excluded cells are configured, the UE considers all detect cells in event evaluation and measurement reporting.

The measurement configuration also includes a reporting configuration, consisting of a reporting criterion (used to trigger the report) and reporting format (which quantities to include in the report). The reporting criterion is either “periodic” or “single event”. The reporting quantity may be RSRP for example.

The measurement configuration also includes a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network.

The measurement configuration also includes a quantity configuration, which defines the measurement filtering configuration used for all event evaluation and related reporting, and for periodical reporting of that measurement.

Finally, the measurement configuration includes Measurement gaps, which are periods that the UE may use to perform measurements.

In case of single event reporting criterion, there are a number of event types defined to trigger measurement reports. Examples of two event types are the following:

Event A3 (see also FIG. 7): For LTE it is also known as “Neighbour becomes offset better than SpCell”. In case of NR it is also known as “Neighbour becomes offset better than PCell/PSCell”. The offset is the cell specific offset part of the measurement object corresponding to the particular neighbor cell.

Event A5 (see also FIG. 8): For LTE it is also known as “SpCell becomes worse than threshold1 and neighbour becomes better than threshold2”. In case of NR it is also known as “PCell/PSCell becomes worse than threshold1 and neighbour becomes better than threshold2”. The thresholds are part of the reporting configuration.

As part of the configuration for events A3, A5 and also other type of events, a hysteresis may also be included. The hysteresis is useful in combination with configuration of “reportOnLeave”, where the UE transmits a report when a trigger quantity of a measurement object ceases to fulfil the criterion (and taking the hysteresis into account) for reporting. For example, as also illustrated in FIG. 7, when using the “reportOnLeave” applied on event A3 for a neighbor cell, the UE transmits a measurement report when the neighbor cell falls below the serving cell plus offset minus the hysteresis. Improved systems and methods for triggering reports are needed.

### SUMMARY

Systems and methods for trigger conditions for event-driven User Equipment (UE) beam reporting are provided. In some embodiments, a method performed by a UE for calculating the quality of its serving link includes: receiving a configuration of a plurality of Downlink (DL) reference signals which represent a plurality of candidate links; receiving a beam indication where a first DL reference signal is used as the Quasi-Colocation (QCL) source for the Physical Downlink Control Channel (PDCCH) and/or the Physical Data Shared Channel (PDSCH) demodulation reference signal (DMRS) of the serving link; measuring a quality of the serving link via measuring on the QCL source of the PDCCH and/or the PDSCH DMRS of the serving link; measuring a quality of one or more of the plurality of candidate links; in response to determining that the quality of the serving link is worse than the quality of the one or more of the plurality of candidate links with best quality: transmitting an event-triggered beam report; and receiving a beam update where the DL reference signal corresponding to the candidate link with the best quality is updated as the QCL source of the PDCCH and/or the PDSCH DMRS of the serving link.

Some embodiments of the present disclosure include a UE calculating the quality of its serving “link” as the quality of one or more Reference Signal(s) (RSs) and/or Synchronization Signal(s) (SSs) used as QCL source of the PDCCH DMRS and/or PDSCH DMRS, wherein the quality of its serving “link” is to be used as input to one or more events which may trigger a measurement report to the network if an associated condition is fulfilled. One example of RS is a CSI-RS resource, and one example of SS is an SSB as defined in TS 38.211. For simplicity the term RS may be used to refer to the SS or CSI-RS in the document.

The one or more RSs and SSs may be transmitted in different spatial direction, possibly called beams. Hence, according to the method, the UE calculates the quality of its serving “link”, comprising one or more beams, as the quality of one or more beams in which control and/or data channels are being transmitted by the network to the UE (i.e., received by the UE), wherein the quality of its serving “link” is to be used as input to one or more events which may trigger a measurement report to the network if an associated condition is fulfilled.

The term serving link is quite general, and two ideas are covered by the methods. In a first set of embodiments, the serving link corresponds to the serving cell, wherein calculating the quality of the serving link comprises the UE calculating the quality of a serving cell i.e., deriving the quality (e.g., RSRP, RSRQ, SINR) of the serving cell, such as the PCell or an SCell of a cell group. In a second set of embodiments, the serving link corresponds to the serving beam, wherein calculating the quality of the serving link comprises the UE calculating the quality of a serving beam (or RSs transmitted in that beam), which is the beam in which the network is transmitting control and data channels to the UE i.e., deriving the quality (e.g., RSRP, RSRQ, SINR) of a specific SSB and/or CSI-RS resource correlated to the beam serving the UE.

The present disclosure also describes a trigger condition for relative events between the serving link, described by a relation between the reference signal used as QCL source of the PDCCH/PDSCH, and a set of reference signals.

Certain embodiments may provide one or more of the following technical advantages. An advantage of some embodiments of the current disclosure is to have an accurate calculation of the quality of the link serving the UE, as according to the method the UE considers its serving link quality as the quality of the actual RSs transmitted with similar properties as control and data channels. Thanks to that, events which have that serving link quality as input will be triggered when a better link is found, compared to the actual link the UE is being served by.

In some embodiments, the configuration is received via Radio Resource Control, RRC. In some embodiments, the method also includes: receiving a command to activate a subset of the configured plurality of DL reference signals.

In some embodiments, the command is a Medium Access Control (MAC) Control Element (CE) command. In some embodiments, measuring quality of a plurality or subset of candidate links comprises measuring on RRC configured and/or activated DL reference signals associated with candidate links.

In some embodiments, the event-triggered beam report comprises the candidate link with the best quality, the associated DL reference signal, and/or measured quantity. In some embodiments, the serving link corresponds to the serving cell, wherein calculating the quality of the serving link comprises calculating the quality of a serving cell.

In some embodiments, deriving the quality of the serving cell, such as the PCell or an SCell of a cell group comprises determining one or more of: Reference signal received power (RSRP); Reference Signal Received Quality (RSRQ); and Signal to interference plus noise ratio (SINR).

In some embodiments, the serving link corresponds to the serving beam, wherein calculating the quality of the serving link comprises calculating the quality of a serving beam. In some embodiments, the beam is the beam in which the network is transmitting control and data channels to the UE. In some embodiments, the quality of the serving link is determined by the QCL source of the PDCCH or the PDSCH DMRS of the serving link.

In some embodiments, the QCL source of the PDCCH or PDSCH DMRS is a DL reference signal. In some embodiments, the UE considers the serving link quality as the quality of a reference signal which is transmitted in a spatial direction which is also transmitting the control channel and/or data channel the UE is monitoring for receiving control information and/or data.

In some embodiments, the DL reference signals representing the candidate links are given as QCL sources of TCI states that are not activated (i.e., all TCI states except the TCI state that is currently activated and used for QCL source for PDSCH DMRS or PDCCH DMRS).

In some embodiments, the UE derives the cell quality of a serving cell by selecting one or more Reference Signals which is/are a transmitted in spatial directions which is also transmitting the control channel and/or data channel the UE is monitoring for receiving control information and/or data.

In some embodiments, determines the beams to be selected for deriving cell quality based on the configuration of the control and/or data channels and the current “state”, wherein the “state” comprises the current active beam transmitting the control and/or data channels.

In some embodiments, the QCL source of the PDCCH or PDSCH DMRS is provided in one or more TCI states. In some embodiments, the UE updates the serving link quality when it receives an indication of activating and/or deactivating a TCI state. In some embodiments, the UE updates the serving link quality when it receives an indication of activating a TCI state.

In some embodiments, a candidate link is represented by a candidate DL reference signal. In some embodiments, the set of DL reference signals representing the candidate links is configured using RRC. In some embodiments, the set of DL reference signals representing the candidate links is configured using RRC, and MAC CE is used to activate a subset of them.

In some embodiments, the DL reference signals representing candidate links are also given as QCL sources in TCI states. In some embodiments, the same measurement quantity is used for the serving link and the candidate links.

In some embodiments, the event-driven beam report is triggered when the quality of the serving link becomes worse than the candidate link with the best quality. In some embodiments, the event-driven beam report is triggered when the quality of the serving link becomes an offset-worse than the candidate link with the best quality. In some embodiments, the UE transmits an event-driven beam report when the serving link becomes worse or offset-worse than at least one of the candidate links being measured by the UE.

In some embodiments, the triggered report is sent over MAC. In some embodiments, the MAC CE includes information regarding the one or multiple candidate links.

In some embodiments, the report is sent over L1. In some embodiments, the UE has multiple TCI states simultaneously activated. In some embodiments, the UE calculates the serving link quality as the strongest quality among the qualities of the RSs used as QCL source of the activated TCIs.

In some embodiments, the UE calculates the serving link quality as the average quality among the qualities of the RSs used as QCL source of the activated TCIs. In some embodiments, the UE calculates the serving link quality as the average quality among the qualities of the RSs used as QCL source of the activated TCIs which are above a determined threshold. In some embodiments, the UE operates in a Fifth Generation (5G) communications network.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Transmission Configuration Indicator (TCI) state information element (Extracted from Third Generation Partnership Project (3GPP) TS 38.331);

FIG. 2 illustrates a two-stage TCI state update;

FIG. 3 illustrates TCI States Activation/Deactivation for UE-specific Physical Downlink Shared Channel (PDSCH) MAC CE (Extracted from FIG. 6.1.3.14-1 of 3GPP TS 38.321);

FIG. 4 illustrates an example of DCI indication of a TCI state;

FIGS. 5 and 6 illustrate examples of activated TCI states and their mapping to TCI field codepoints for “Joint DL/UL TCI”;

FIG. 7 illustrates Event A3: For LTE it is also known as “Neighbour becomes offset better than SpCell”;

FIG. 8 illustrates Event A5: For LTE it is also known as “SpCell becomes worse than threshold1 and neighbour becomes better than threshold2”;

FIG. 9 illustrates a method of operating a UE, according to some embodiments of the current disclosure;

FIG. 10 shows an example of a communication system in accordance with some embodiments;

FIG. 11 shows a UE in accordance with some embodiments;

FIG. 12 shows a network node in accordance with some embodiments;

FIG. 13 is a block diagram of a host, which may be an embodiment of the host of FIG. 10, in accordance with various aspects described herein;

FIG. 14 is a block diagram illustrating a virtualization environment in which functions implemented by some embodiments may be virtualized; and

FIG. 15 shows a communication diagram of a host communicating via a network node with a UE over a partially wireless connection in accordance with some embodiments.

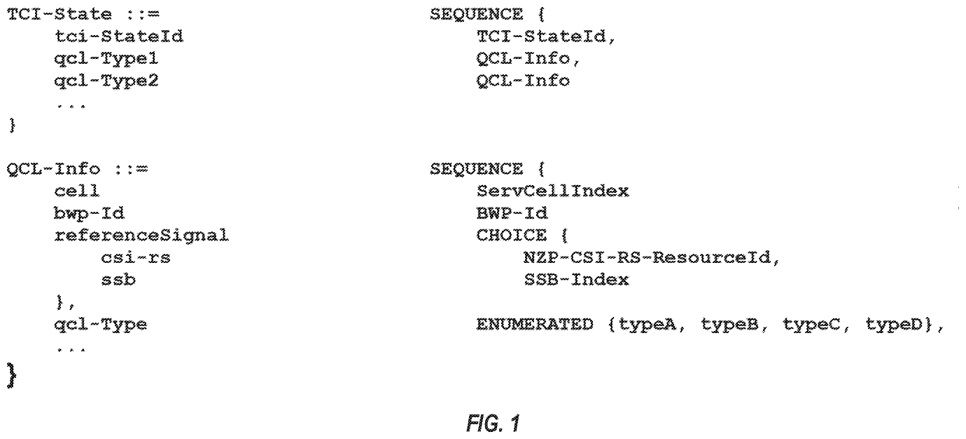

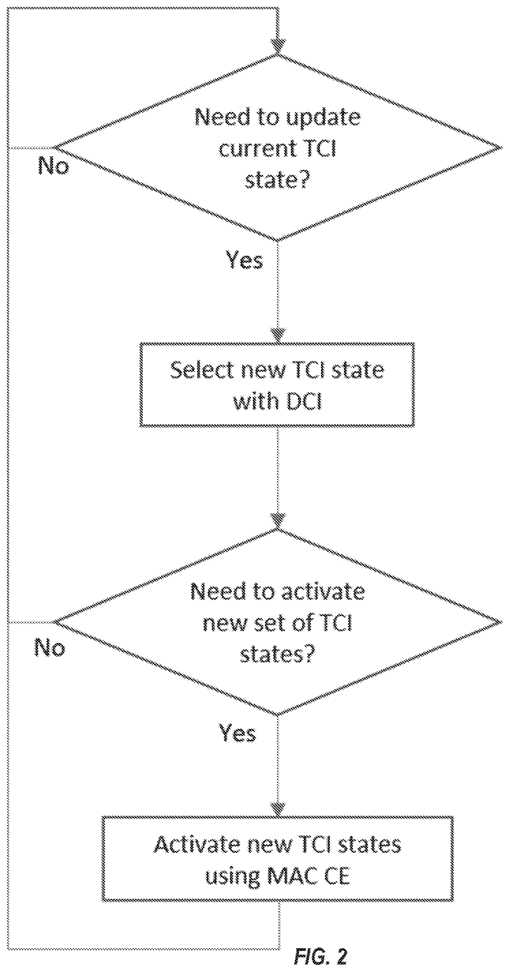

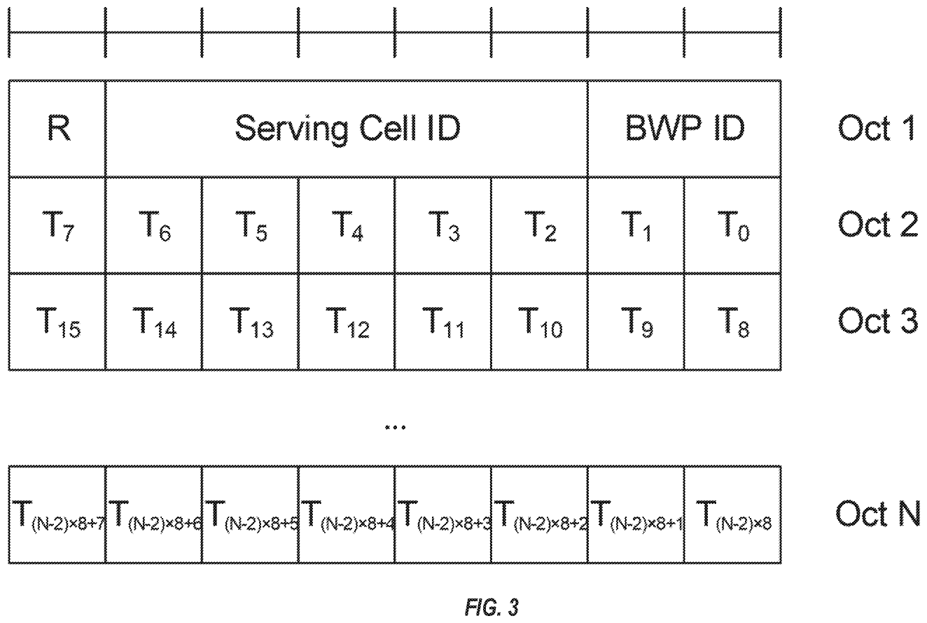

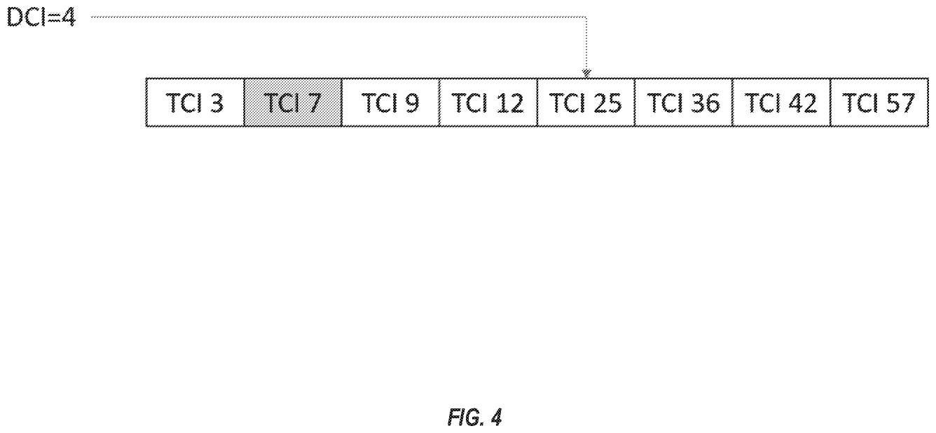

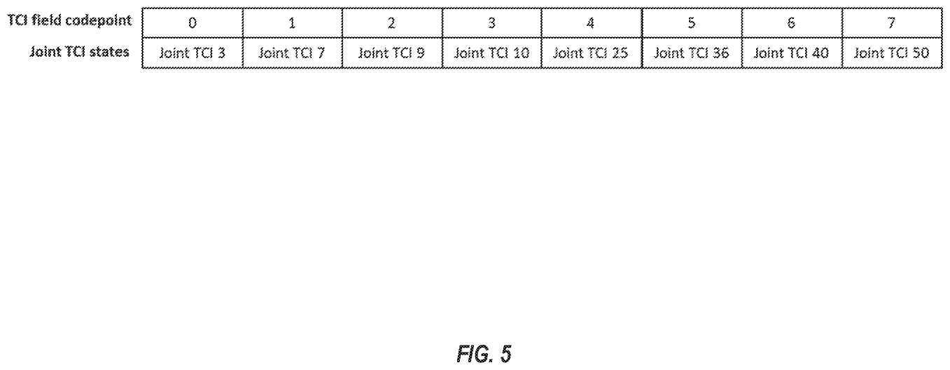

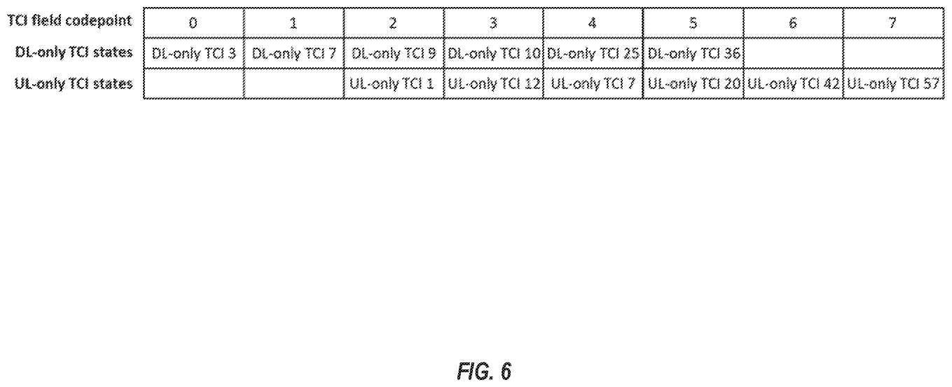

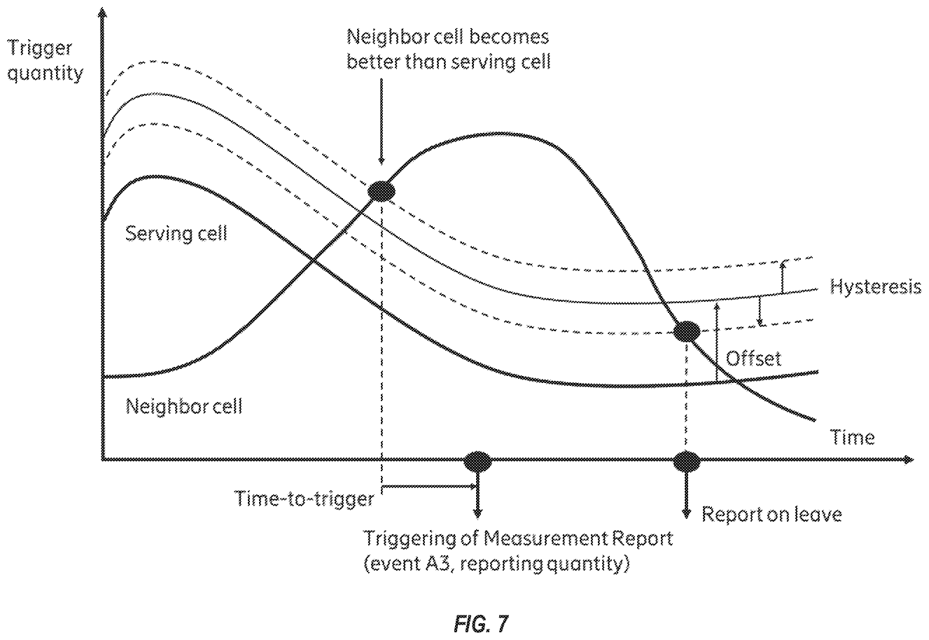

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenges. In state-of-the-art solutions of mobility, based on RRC, the quality of the serving link is defined by a set of reference signals, e.g., all SSBs that are associated with the same Physical Cell Identity (PCI). In RRC in 5G NR, for example, the quality of the serving link may correspond to the quality of a serving cell, such as the cell-based Reference Signal Received Power (RSRP) and/or Reference Signal Received Quality (RSRQ) of a special cell (SpCell), like the RSRP of a PCell based on SSB measurements. The cell quality may be derived based on measurements on one or more RSs (e.g., one or more SSBs) of the serving cell which are transmitted in different spatial directions (referred as beams) e.g., by considering the quality of the serving cell the quality of the strongest SSB of that cell, or by averaging the strongest SSB of that cell with K−1 strongest SSBs of that cell (depending on network configuration).

However, the actual quality of the serving link in which the UE is receiving control channels and data, is determined by the quality of to one or a smaller subset of these reference signals of the serving cell, i.e., the reference signals configured as QCL source (e.g., Type D) of the Demodulation Reference Signals (DMRS) of control and/or data channels (Physical Downlink Control Channel (PDCCH) and/or Physical Downlink Shared Channel (PDSCH)). In other words, the UE may consider its serving cell quality as the quality of the strongest beam or as the average of strongest K beams, without necessarily considering whether these are the beams in which data and control channels are being transmitted by the network. Consequently, the cell quality may not reflect the actual quality the UE experiences in that cell.

This situation may lead to that events (e.g., like an A3 event defined in RRC) that are related to the relative quality between the actual serving link (i.e., the reference signals that serve as QCL source of the PDCCH/PDSCH DMRS) and other neighbour and/or candidate links will not lead to measurements reports and will not be known to the network for triggering mobility procedures, such as a handover, or any other mobility procedure based on a serving link. It may also happen that if network wants to know if the serving cell quality is below a threshold, reports are not transmitted. For example, assume that the UE is configured with a single DL reference signal (e.g., SSB1) that serves as QCL source of the PDCCH/PDSCH DMRS, and the link quality for this DL reference signal becomes poor. In case the quality of the serving link (e.g., cell quality) is defined by averaging a number of detected SSBs of that cell above a threshold, and the quality of another SSB of that cell might still have a good link quality, and the event driven report will not be triggered (even though the actual service link quality becomes poor, and the UE cannot be served properly).

Certain aspects of the disclosure and their embodiments may provide solutions to these or other challenges.

The core idea in the present disclosure is a User Equipment (UE) calculating the quality of its serving “link” as the quality of one or more Reference Signal(s) (RSs) and/or Synchronization Signal(s) (SSs) used as QCL source of the PDCCH DMRS and/or PDSCH DMRS, wherein the quality of its serving “link” is to be used as input to one or more events which may trigger a measurement report to the network if an associated condition is fulfilled. One example of RS is a CSI-RS resource, and one example of SS is an SSB as defined in TS 38.211. For simplicity the term RS may be used to refer to the SS or CSI-RS in the document.

The one or more RSs and SSs may be transmitted in different spatial direction, possibly called beams. Hence, according to the method, the UE calculates the quality of its serving “link”, comprising one or more beams, as the quality of one or more beams in which control and/or data channels are being transmitted by the network to the UE (i.e., received by the UE), wherein the quality of its serving “link” is to be used as input to one or more events which may trigger a measurement report to the network if an associated condition is fulfilled.

The term serving link is quite general, and two ideas are covered by the methods.
In a first set of embodiments, the serving link corresponds to the serving cell, wherein calculating the quality of the serving link comprises the UE calculating the quality of a serving cell i.e., deriving the quality (e.g., RSRP, RSRQ, SINR) of the serving cell, such as the PCell or an SCell of a cell group.
In a second set of embodiments, the serving link corresponds to the serving beam, wherein calculating the quality of the serving link comprises the UE calculating the quality of a serving beam (or RSs transmitted in that beam), which is the beam in which the network is transmitting control and data channels to the UE i.e., deriving the quality (e.g., RSRP, RSRQ, SINR) of a specific SSB and/or CSI-RS resource correlated to the beam serving the UE.

The present disclosure also describes a trigger condition for relative events between the serving link, described by a relation between the reference signal used as QCL source of the PDCCH/PDSCH, and a set of reference signals.

The core idea in the present disclosure is a User Equipment (UE) calculating the quality of its serving “link” as the quality of one or more Reference Signal(s) (RSs) and/or Synchronization Signal(s) (SSs) used as QCL source of the PDCCH DMRS and/or PDSCH DMRS, wherein the quality of its serving “link” is to be used as input to one or more events which may trigger a measurement report to the network if an associated condition is fulfilled.

Certain embodiments may provide one or more of the following technical advantages. An advantage of some embodiments of the current disclosure is to have an accurate calculation of the quality of the link serving the UE, as according to the method the UE considers its serving link quality as the quality of the actual RSs transmitted with similar properties as control and data channels. Thanks to that, events which have that serving link quality as input will be triggered when a better link is found, compared to the actual link the UE is being served by.

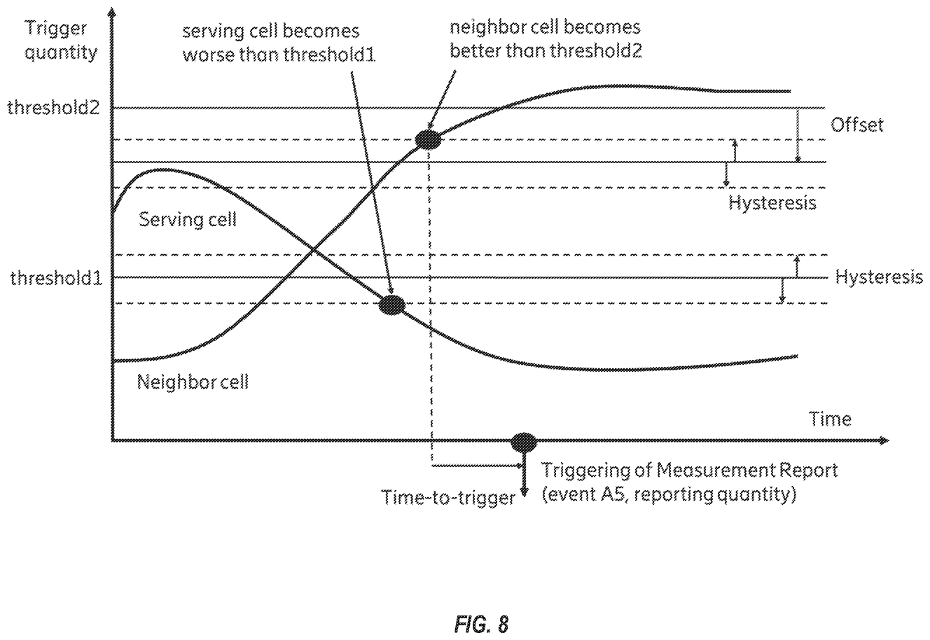

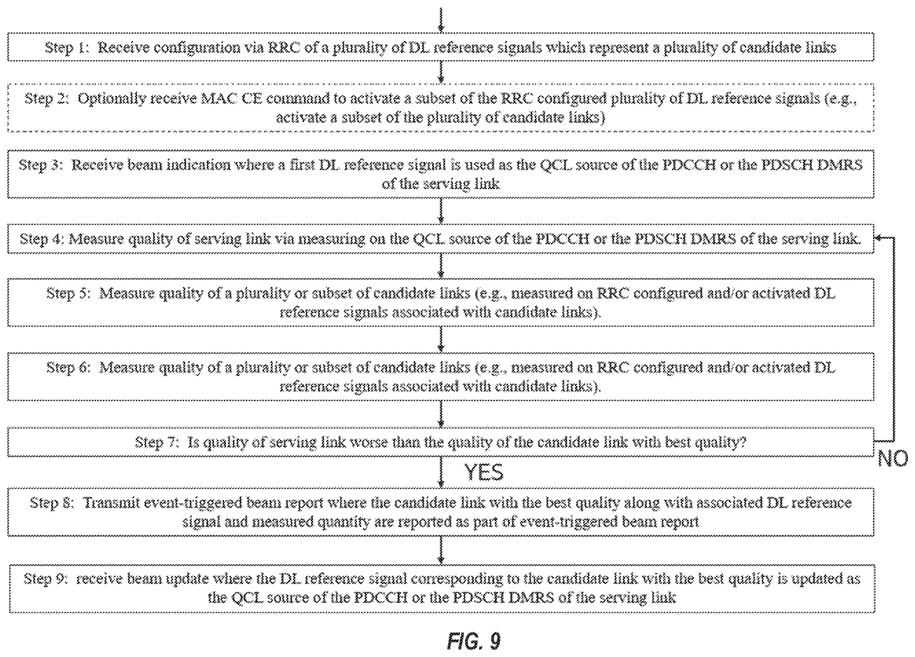

FIG. 9 illustrates a method of operating a UE, according to some embodiments of the current disclosure.

Systems and methods for trigger conditions for event-driven User Equipment (UE) beam reporting are provided. In some embodiments, a method performed by a UE for calculating the quality of its serving link includes: receiving (Step 1) a configuration of a plurality of Downlink (DL) reference signals which represent a plurality of candidate links; receiving (Step 3) a beam indication where a first DL reference signal is used as the Quasi-Colocation (QCL) source for the Physical Downlink Control Channel (PDCCH) and/or the Physical Data Shared Channel (PDSCH) demodulation reference signal (DMRS) of the serving link; measuring (Step 4) a quality of the serving link via measuring on the QCL source of the PDCCH and/or the PDSCH DMRS of the serving link; measuring (Step 5) a quality of one or more of the plurality of candidate links; in response to determining (Step 7) that the quality of the serving link is worse than the quality of the one or more of the plurality of candidate links with best quality: transmitting (Step 8) an event-triggered beam report; and receiving (Step 9) a beam update where the DL reference signal corresponding to the candidate link with the best quality is updated as the QCL source of the PDCCH and/or the PDSCH DMRS of the serving link.

Certain embodiments may provide one or more of the following technical advantages. An advantage of some embodiments of the current disclosure is to have an accurate calculation of the quality of the link serving the UE, as according to the method the UE considers its serving link quality as the quality of the actual RSs transmitted with similar properties as control and data channels. Thanks to that, events which have that serving link quality as input will be triggered when a better link is found, compared to the actual link the UE is being served by.

In one general embodiment the quality of the serving link is determined by the QCL source of the PDCCH or the PDSCH DMRS of the serving link. This is shown in Step 4 of FIG. 9.

In a related embodiment, the QCL source of the PDCCH or PDSCH DMRS is a DL reference signal. The DL reference signal can be for example, an SSB, a DMRS, or a CSI-RS.

In one embodiment, the UE considers the serving link quality as the quality of a reference signal (e.g., SSB quality, SS-RSRP as defined in TS 38.215) which is transmitted in a spatial direction (beam) which is also transmitting the control channel and/or data channel the UE is monitoring for receiving control information and/or data.

In one embodiment, the UE derives the cell quality of a serving cell (e.g., cell based RSRP, and/or RSRQ and/or SINR) by selecting one or more Reference Signals (e.g., SSBs associated to SSB indexes) which is/are a transmitted in spatial directions (beams) which is also transmitting the control channel and/or data channel the UE is monitoring for receiving control information and/or data. In other words, the UE determines the beams to be selected for deriving cell quality based on the configuration of the control and/or data channels and the current “state”, wherein the “state” comprises the current active beam transmitting the control and/or data channels.

In a related embodiment, the QCL source of the PDCCH or PDSCH DMRS is provided (configured) in one or more TCI states. As shown in Step 3 of FIG. 9, the UE receives configuration of a plurality of TCI states wherein each TCI state contains a DL reference signal that can be used as QCL source of the PDCCH or the PDSCH DMRS. When the network indicates or activates one such TCI state to the UE, the UE uses the DL reference signal indicated in the indicated TCI state as QCL source of the PDCCH or PDSCH DMRS. The indication or activation of the TCI state can be performed via RRC signaling, MAC CE signaling, or DCI signaling or a combination of any of these types of signaling.

In one embodiment the UE updates the serving link quality when it receives an indication of activating and/or deactivating a TCI state (and/or a change of activated TCI state). For example, if the UE in time TO has TCI state ID=1 activated (whose QCL source is SSB index=X) the UE considers the serving link quality as the quality of the SSB index=X. Upon receiving a signaling from network indicating that TCI state ID=X is to be deactivated and that TCI state Id=2 is to be activated (whose QCL source is SSB index=Y), the UE updates its serving link quality and considers it as the quality of the SSB index=Y.

In one embodiment the UE updates the serving link quality when it receives an indication of activating a TCI state (addition of an active TCI state). For example, if the UE in time T0 has TCI state ID=1 activated (whose QCL source is SSB index=X) the UE considers the serving link quality as the quality of the SSB index=X. Upon receiving a signaling from network indicating that TCI state ID=Y is to be activated too (whose QCL source is SSB index=Y), the UE updates its serving link quality and considers it as a combined quality of the SSB index=Y and SSB index=X e.g., a sum of the qualities of SSB index X and SSB index Y; or the quality of the strongest SSB out of SSB index X and SSB index Y.

The method also introduces the notion of a candidate or neighbour link, which is another link which may also be used as input to an event with the serving link. For example, if one considers an RRC measurement report triggered upon the fulfillment of an A3 event, a serving link may correspond to the serving cell quality, while the candidate or neighbour link may correspond to a neighbour cell. In another example, if one considers a CSI report (or beam measurement report) triggered when the quality of a candidate beam is an offset better (or better) than the quality of the serving beam, the candidate link may correspond to a candidate beam, which may be a beam transmitting an SSB or CSI-RS configured as QCL source of a TCI state of the same cell as the serving beam, and possibly in the same bandwidth part (BWP).

In an additional embodiment, a candidate link is represented by a candidate DL reference signal. The DL reference signal can be for example, an SSB or a CSI-RS.

As shown in Step 1 of FIG. 9, in one embodiment, the set of DL reference signals representing the candidate links is configured using RRC.

In one embodiment, the set of DL reference signals representing the candidate links is configured using RRC, and MAC CE is used to activate a subset of them. This embodiment corresponds to Steps 1 (RRC configuration of candidate links) and 2 (activation of subset of the configured links) of FIG. 9.

In an alternative embodiment, the DL reference signals representing candidate links are also given as QCL sources in TCI states (i.e., TCI states different from the TCI state that provides the QCL source of the PDCCH or PDSCH DMRS corresponding to the serving link). In other words, the serving link quality is determined based on the RSs which are QCL source of the activated TCI states, while a candidate link is determined based on any RS configured as QCL source of a configured TCI state (not activated).
Events are only triggered for links in an active Bandwidth Part (BWP). For example, the serving link quality is determined based on the RSs which are QCL source of the activated TCI states, i.e., in the active BQP, while a candidate link is determined based on any RS configured as QCL source of a configured TCI state (not activated) in the same current active BWP.
Events are only triggered for links in the current serving cell, like the PCell i.e., not across cells. For example, the serving link quality is determined based on the RSs which are QCL source of the activated TCI states in a serving cell like the PCell, while a candidate link is determined based on any RS configured as QCL source of a configured TCI state (not activated) in the same serving cell. In other words, the UE compares a beam which is being served by with one or more candidate beams in the same cell, which the network may activate.

As shown in Steps 5 and 6 of FIG. 9, the UE measures the quality of the serving link and the plurality or subset of candidate links. In some embodiments, the multiple steps indicate that the UE might perform multiple measurements on the same DL reference signals. The quality of a DL reference signal can be represented by any measurement quantity, for example RSRP, RSRQ, RSSI, or SINR. The corresponding measurement quality can also be filtered. In a preferred embodiment, the same measurement quantity is used for the serving link and the candidate links.

In one embodiment, as shown in Step 7 of FIG. 9, the event-driven beam report is triggered when the quality of the serving link becomes worse than the candidate link with the best quality. In some embodiments, the event-driven beam report is triggered when the quality of the serving link becomes an offset-worse than the candidate link with the best quality (i.e., quality of the serving link is worse than the quality of the candidate link with best quality minus a predefined/preconfigured offset value). This ‘offset worse than the candidate link with best quality’ triggering condition can be used to ensure that there are no frequent event-driven beam reports when the link with the best quality flip-flops between the serving link and a candidate link.

In some embodiments, the UE may transmit an event-driven beam report when the serving link becomes worse or offset-worse than at least one of the candidate links being measured by the UE. If the serving link becomes worse or offset-worse than multiple candidate links being measured, then the UE includes information regarding the multiple candidate links (e.g., identifiers of DL reference signals and the measured quality values such as SS-RSRP and/or SS-SINR values) in the event-triggered report. Then, network then can choose one of the multiple candidate links reported as the serving link.

As shown in Step 9 of FIG. 9, to update a candidate link reported as the serving link, the UE receives from the network a beam update where the DL reference signal corresponding to the candidate link with the best quality is updated as the QCL source of the PDCCH or the PDSCH DMRS of the serving cell.

In one embodiment, the triggered report is sent over MAC. The MAC CE may include information regarding the one or multiple candidate links (e.g., identifier(s) of DL reference signal(s) and/or the measured quality values).

In an alternative embodiment, the report is sent over L1 e.g., as a CSI report over PUCCH and/or PUSCH.

In a set of embodiments, the UE may have multiple TCI states simultaneously activated e.g., TCI state-1, . . . , TCI state-K, implying that the UE may then receive PDCCH and/or PDSCH using any of these TCI states. In this case, the serving link quality may be determined based on the quality of one or more of these. One possible scenario where this may occur is when the UE is configured with multiple TRPs.

In one embodiment, the UE calculates the serving link quality as the strongest quality among the qualities of the RSs used as QCL source of the activated TCIs. For example, if the UE has activated both TCI state X (with SSB whose SSB index=x1 as QCL source e.g., type D) and TCI state Y (with SSB whose SSB index=y1 as QCL source e.g., type D), the UE measures the RSRP of SSB whose SSB index=x1, denoted SS-RSRP(x1) and the UE measures the RSRP of SSB whose SSB index=y1, denoted SS-RSRP(y1), and considers the serving link quality to be the maximum (SS-RSRP(y1), SS-RSRP(x1)). Other measurement quantities could be considered instead or in addition to RSRP, such as RSRQ, SINR, RSSI, etc.

In one embodiment, the UE calculates the serving link quality as the average quality among the qualities of the RSs used as QCL source of the activated TCIs. For example, if the UE has activated both TCI state X (with SSB whose SSB index=x1 as QCL source e.g., type D) and TCI state Y (with SSB whose SSB index=y1 as QCL source e.g., type D), the UE measures the RSRP of SSB whose SSB index=x1, denoted SS-RSRP(x1) and the UE measures the RSRP of SSB whose SSB index=y1, denoted SS-RSRP(y1), and considers the serving link quality to be an average of (SS-RSRP(y1) and SS-RSRP(x1)).

In one embodiment, the UE calculates the serving link quality as the average quality among the qualities of the RSs used as QCL source of the activated TCIs which are above a determined threshold. For example, if the UE has activated both TCI state X (with SSB whose SSB index=x1 as QCL source e.g., type D), TCI state Y (with SSB whose SSB index=y1 as QCL source e.g., type D), TCI state Z (with SSB whose SSB index=z1 as QCL source e.g., type D), the UE measures the RSRP of SSB whose SSB index=x1, denoted SS-RSRP(x1), the UE measures the RSRP of SSB whose SSB index=y1, denoted SS-RSRP(y1), the UE measures the RSRP of SSB whose SSB index=z1, denoted SS-RSRP(z1), and, if only RSRP(x1) and RSRP(y1) are above a threshold, the UE considers the serving link quality to be an average of (SS-RSRP(y1) and SS-RSRP(x1)).

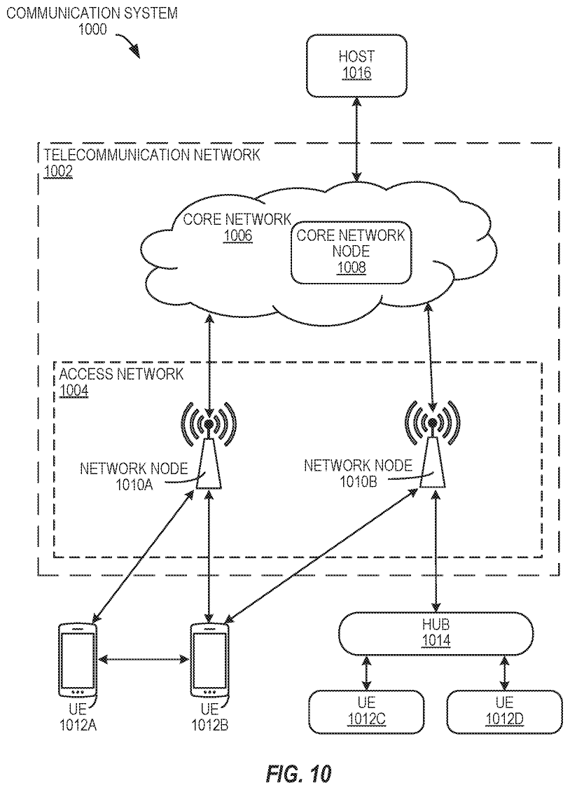

FIG. 10 shows an example of a communication system 1000 in accordance with some embodiments.

In the example, the communication system 1000 includes a telecommunication network 1002 that includes an access network 1004, such as a Radio Access Network (RAN), and a core network 1006, which includes one or more core network nodes 1008. The access network 1004 includes one or more access network nodes, such as network nodes 1010A and 1010B (one or more of which may be generally referred to as network nodes 1010), or any other similar Third Generation Partnership Project (3GPP) access node or non-3GPP Access Point (AP). The network nodes 1010 facilitate direct or indirect connection of User Equipment (UE), such as by connecting UEs 1012A, 1012B, 1012C, and 1012D (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system 1000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1002 is a cellular network that implements 3GPP standardized features. Accordingly, the telecommunication network 1002 may support network slicing to provide different logical networks to different devices that are connected to the telecommunication network 1002. For example, the telecommunication network 1002 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1014 communicates with the access network 1004 to facilitate indirect communication between one or more UEs (e.g., UE 1012C and/or 1012D) and network nodes (e.g., network node 110B). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a Virtual Reality (VR) headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010B. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to a Machine-to-Machine (M2M) service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 110B. In other embodiments, the hub 1014 may be a non-dedicated hub—that is, a device which is capable of operating to route communications between the UEs and the network node 1010B, but which is additionally capable of operating as a communication start and/or end point for certain data channels.

FIG. 11 shows a UE 1100 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1102 may include multiple Central Processing Units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging the power source 1108. Power circuitry may perform any formatting, converting, or other modification to the power from the power source 1108 to make the power suitable for the respective components of the UE 1100 to which power is supplied.

The memory 1110 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1110 may allow the UE 1100 to access instructions, application programs, and the like stored on transitory or non-transitory memory media, to off-load data, or to upload data. An article of manufacture, such as one utilizing a communication system, may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., the antenna 1122) and may share circuit components, software, or firmware, or alternatively be implemented separately.

In the illustrated embodiment, communication functions of the communication interface 1112 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1112, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

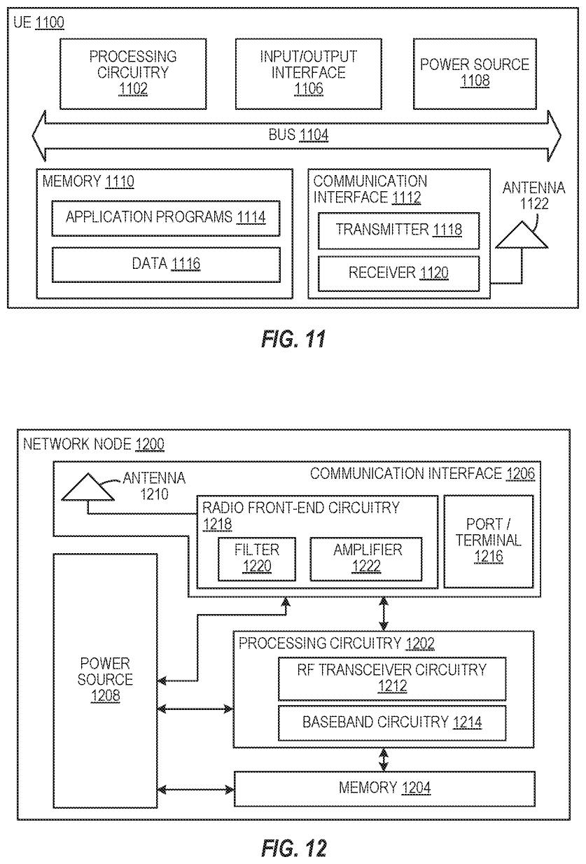

FIG. 12 shows a network node 1200 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes processing circuitry 1202, memory 1204, a communication interface 1206, and a power source 1208. The network node 1200 may be composed of multiple physically separate components (e.g., a Node B component and an RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1200 may be configured to support multiple RATs. In such embodiments, some components may be duplicated (e.g., separate memory 1204 for different RATs) and some components may be reused (e.g., an antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1200.

The processing circuitry 1202 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1200 components, such as the memory 1204, to provide network node 1200 functionality.

In some embodiments, the processing circuitry 1202 includes a System on a Chip (SOC). In some embodiments, the processing circuitry 1202 includes one or more of Radio Frequency (RF) transceiver circuitry 1212 and baseband processing circuitry 1214. In some embodiments, the RF transceiver circuitry 1212 and the baseband processing circuitry 1214 may be on separate chips (or sets of chips), boards, or units, such as radio units and digital units. In alternative embodiments, part or all of the RF transceiver circuitry 1212 and the baseband processing circuitry 1214 may be on the same chip or set of chips, boards, or units.

The memory 1204 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and the memory 1204 are integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. The radio front-end circuitry 1218 comprises filters 1220 and amplifiers 1222. The radio front-end circuitry 1218 may be connected to the antenna 1210 and the processing circuitry 1202. The radio front-end circuitry 1218 may be configured to condition signals communicated between the antenna 1210 and the processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of the filters 1220 and/or the amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface 1206 may comprise different components and/or different combinations of components.

In certain alternative embodiments, the network node 1200 does not include separate radio front-end circuitry 1218; instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes the one or more ports or terminals 1216, the radio front-end circuitry 1218, and the RF transceiver circuitry 1212 as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, the communication interface 1206, and/or the processing circuitry 1202 may be configured to perform any receiving operations and/or certain obtaining operations described herein as being performed by the network node 1200. Any information, data, and/or signals may be received from a UE, another network node, and/or any other network equipment. Similarly, the antenna 1210, the communication interface 1206, and/or the processing circuitry 1202 may be configured to perform any transmitting operations described herein as being performed by the network node 1200. Any information, data, and/or signals may be transmitted to a UE, another network node, and/or any other network equipment.

The power source 1208 provides power to the various components of the network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid or an electricity outlet) via input circuitry or an interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

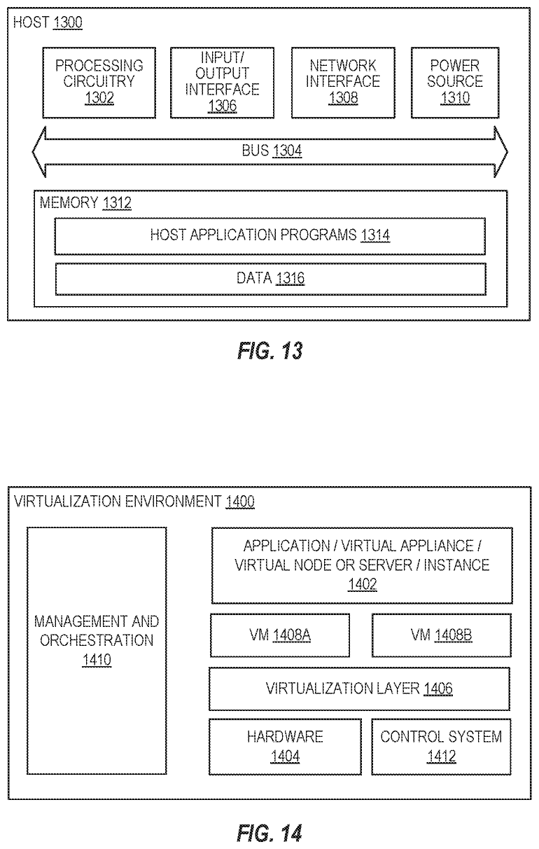

FIG. 13 is a block diagram of a host 1300, which may be an embodiment of the host 1016 of FIG. 10, in accordance with various aspects described herein. As used herein, the host 1300 may be or comprise various combinations of hardware and/or software including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and memory 1312. Other components may be included in other embodiments. Features of these components may be substantially similar to those described with respect to the devices of previous figures, such as FIGS. 11 and 12, such that the descriptions thereof are generally applicable to the corresponding components of the host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for Over-The-Top (OTT) services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or VM Monitors (VMMs)), provide VMs 1408A and 1408B (one or more of which may be generally referred to as VMs 1408), and/or perform any of the functions, features, and/or benefits described in relation with some embodiments described herein. The virtualization layer 1406 may present a virtual operating platform that appears like networking hardware to the VMs 1408.

The VMs 1408 comprise virtual processing, virtual memory, virtual networking, or interface and virtual storage, and may be run by a corresponding virtualization layer 1406. Different embodiments of the instance of a virtual appliance 1402 may be implemented on one or more of the VMs 1408, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1408 may be a software implementation of a physical machine that runs programs as if they were executing on a physical, non-virtualized machine. Each of the VMs 1408, and that part of the hardware 1404 that executes that VM, be it hardware dedicated to that VM and/or hardware shared by that VM with others of the VMs 1408, forms separate virtual network elements. Still in the context of NFV, a virtual network function is responsible for handling specific network functions that run in one or more VMs 1408 on top of the hardware 1404 and corresponds to the application 1402.

The hardware 1404 may be implemented in a standalone network node with generic or specific components. The hardware 1404 may implement some functions via virtualization. Alternatively, the hardware 1404 may be part of a larger cluster of hardware (e.g., such as in a data center or CPE) where many hardware nodes work together and are managed via management and orchestration 1410, which, among others, oversees lifecycle management of the applications 1402. In some embodiments, the hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1412 which may alternatively be used for communication between hardware nodes and radio units.

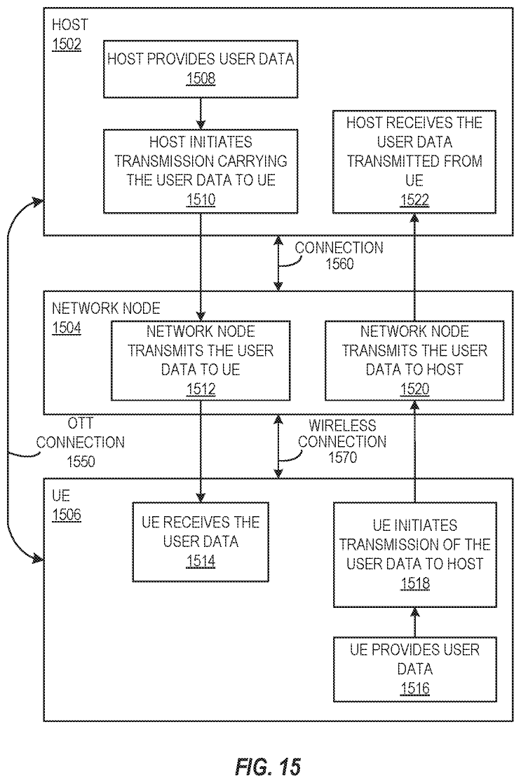

FIG. 15 shows a communication diagram of a host 1502 communicating via a network node 1504 with a UE 1506 over a partially wireless connection in accordance with some embodiments. Example implementations, in accordance with various embodiments, of the UE (such as the UE 1012A of FIG. 10 and/or the UE 1100 of FIG. 11), the network node (such as the network node 1010A of FIG. 10 and/or the network node 1200 of FIG. 12), and the host (such as the host 1016 of FIG. 10 and/or the host 1300 of FIG. 13) discussed in the preceding paragraphs will now be described with reference to FIG. 15.

Like the host 1300, embodiments of the host 1502 include hardware, such as a communication interface, processing circuitry, and memory. The host 1502 also includes software, which is stored in or is accessible by the host 1502 and executable by the processing circuitry. The software includes a host application that may be operable to provide a service to a remote user, such as the UE 1506 connecting via an OTT connection 1550 extending between the UE 1506 and the host 1502. In providing the service to the remote user, a host application may provide user data which is transmitted using the OTT connection 1550.

The network node 1504 includes hardware enabling it to communicate with the host 1502 and the UE 1506 via a connection 1560. The connection 1560 may be direct or pass through a core network (like the core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by the UE 1506 and executable by the UE's processing circuitry. The software includes a client application, such as a web browser or operator-specific “app” that may be operable to provide a service to a human or non-human user via the UE 1506 with the support of the host 1502. In the host 1502, an executing host application may communicate with the executing client application via the OTT connection 1550 terminating at the UE 1506 and the host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via the connection 1560 between the host 1502 and the network node 1504 and via a wireless connection 1570 between the network node 1504 and the UE 1506 to provide the connection between the host 1502 and the UE 1506. The connection 1560 and the wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504 in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR, or AR which it can broadcast, multicast, or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1550 between the host 1502 and the UE 1506 in response to variations in the measurement results. The measurement procedure and/or the network functionality for reconfiguring the OTT connection 1550 may be implemented in software and hardware of the host 1502 and/or the UE 1506. In some embodiments, sensors (not shown) may be deployed in or in association with other devices through which the OTT connection 1550 passes; the sensors may participate in the measurement procedure by supplying values of the monitored quantities exemplified above, or by supplying values of other physical quantities from which software may compute or estimate the monitored quantities. The reconfiguring of the OTT connection 1550 may include message format, retransmission settings, preferred routing, etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency, and the like by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

### Group A Embodiments

Embodiment 1: A method performed by a User Equipment, UE, for calculating the quality of its serving link, the method comprising one or more of: a. receiving (Step 1) configuration of a plurality of Downlink, DL, reference signals which represent a plurality of candidate links; b. receiving (Step 2) a command to activate a subset of the configured plurality of DL reference signals; c. receiving (Step 3) beam indication where a first DL reference signal is used as the Quasi-Colocation, QCL, source for the physical downlink control channel, PDCCH, and/or the Physical Data Shared Channel, PDSCH, demodulation reference signal, DMRS, of the serving link; d. measuring (Step 4) a quality of the serving link via measuring on the QCL source of the PDCCH and/or the PDSCH DMRS of the serving link; e. measuring (Step 5) quality of a plurality of or subset of candidate links; f. measuring (Step 6) quality of a plurality or subset of candidate links; g. determining (Step 7) if the quality of the serving link is worse than the quality of the candidate link with best quality; h. transmitting (Step 8) event-triggered beam report; and i. receiving (Step 9) beam update where the DL reference signal corresponding to the candidate link with the best quality is updated as the QCL source of the PDCCH and/or the PDSCH DMRS of the serving link.

Embodiment 2: The method of embodiment 1 wherein the configuration is received via Radio Resource Control, RRC.

Embodiment 3: The method of any of the previous embodiments wherein the command is a Medium Access Control, MAC, Control Element, CE, command.

Embodiment 4: The method of any of the previous embodiments wherein the command is to activate a subset of the plurality of candidate links.

Embodiment 5: The method of any of the previous embodiments wherein measuring quality of a plurality or subset of candidate links comprises measuring on RRC configured and/or activated DL reference signals associated with candidate links.

Embodiment 6: The method of any of the previous embodiments wherein the event-triggered beam report comprises the candidate link with the best quality, the associated DL reference signal, and/or measured quantity.

Embodiment 7: The method of any of the previous embodiments wherein the serving link corresponds to the serving cell, wherein calculating the quality of the serving link comprises calculating the quality of a serving cell.

Embodiment 8: The method of any of the previous embodiments wherein deriving the quality of the serving cell, such as the PCell or an SCell of a cell group comprises determining one or more of: Reference signal received power, RSRP; Reference Signal Received Quality, RSRQ; and Signal to interference plus noise ratio, SINR.

Embodiment 9: The method of any of the previous embodiments wherein the serving link corresponds to the serving beam, wherein calculating the quality of the serving link comprises calculating the quality of a serving beam (or RSs transmitted in that beam).

Embodiment 10: The method of any of the previous embodiments wherein the beam is the beam in which the network is transmitting control and data channels to the UE.

Embodiment 11: The method of any of the previous embodiments wherein the quality of the serving link is determined by the QCL source of the PDCCH or the PDSCH DMRS of the serving link.

Embodiment 12: The method of any of the previous embodiments wherein the QCL source of the PDCCH or PDSCH DMRS is a DL reference signal (the DL reference signal can be for example, an SSB, a DMRS, or a CSI-RS).

Embodiment 13: The method of any of the previous embodiments wherein the UE considers the serving link quality as the quality of a reference signal which is transmitted in a spatial direction (beam) which is also transmitting the control channel and/or data channel the UE is monitoring for receiving control information and/or data.

Embodiment 14: The method of any of the previous embodiments wherein the UE derives the cell quality of a serving cell by selecting one or more Reference Signals which is/are a transmitted in spatial directions (beams) which is also transmitting the control channel and/or data channel the UE is monitoring for receiving control information and/or data.

Embodiment 15: The method of any of the previous embodiments wherein determines the beams to be selected for deriving cell quality based on the configuration of the control and/or data channels and the current “state”, wherein the “state” comprises the current active beam transmitting the control and/or data channels.

Embodiment 16: The method of any of the previous embodiments wherein the QCL source of the PDCCH or PDSCH DMRS is provided (configured) in one or more TCI states.

Embodiment 17: The method of any of the previous embodiments wherein the UE updates the serving link quality when it receives an indication of activating and/or deactivating a TCI state (and/or a change of activated TCI state).

Embodiment 18: The method of any of the previous embodiments wherein the UE updates the serving link quality when it receives an indication of activating a TCI state (addition of an active TCI state).

Embodiment 19: The method of any of the previous embodiments wherein a candidate link is represented by a candidate DL reference signal. The DL reference signal can be for example, an SSB or a CSI-RS.

Embodiment 20: The method of any of the previous embodiments wherein the set of DL reference signals representing the candidate links is configured using RRC.

Embodiment 21: The method of any of the previous embodiments wherein the set of DL reference signals representing the candidate links is configured using RRC, and MAC CE is used to activate a subset of them.

Embodiment 22: The method of any of the previous embodiments wherein the DL reference signals representing candidate links are also given as QCL sources in TCI states (i.e., TCI states different from the TCI state that provides the QCL source of the PDCCH or PDSCH DMRS corresponding to the serving link).

Embodiment 23: The method of any of the previous embodiments wherein the same measurement quantity is used for the serving link and the candidate links.

Embodiment 24: The method of any of the previous embodiments wherein the event-driven beam report is triggered when the quality of the serving link becomes worse than the candidate link with the best quality.

Embodiment 25: The method of any of the previous embodiments wherein the event-driven beam report is triggered when the quality of the serving link becomes an offset-worse than the candidate link with the best quality (i.e., quality of the serving link is worse than the quality of the candidate link with best quality minus a predefined/preconfigured offset value).

Embodiment 26: The method of any of the previous embodiments wherein the UE may transmit an event-driven beam report when the serving link becomes worse or offset-worse than at least one of the candidate links being measured by the UE.

Embodiment 27: The method of any of the previous embodiments wherein the triggered report is sent over MAC.

Embodiment 28: The method of any of the previous embodiments wherein the MAC CE may include information regarding the one or multiple candidate links (e.g., identifier(s) of DL reference signal(s) and/or the measured quality values.

Embodiment 29: The method of any of the previous embodiments wherein the report is sent over L1 e.g., as a CSI report over PUCCH and/or PUSCH.

Embodiment 30: The method of any of the previous embodiments wherein the UE may have multiple TCI states simultaneously activated e.g., TCI state-1, . . . , TCI state-K, implying that the UE may then receive PDCCH and/or PDSCH using any of these TCI states.

Embodiment 31: The method of any of the previous embodiments wherein the UE calculates the serving link quality as the strongest quality among the qualities of the RSs used as QCL source of the activated TCIs.

Embodiment 32: The method of any of the previous embodiments wherein the UE calculates the serving link quality as the average quality among the qualities of the RSs used as QCL source of the activated TCIs.

Embodiment 33: The method of any of the previous embodiments wherein the UE calculates the serving link quality as the average quality among the qualities of the RSs used as QCL source of the activated TCIs which are above a determined threshold.

Embodiment 34: The method of any of the previous embodiments wherein the UE operates in a Fifth Generation, 5G, communications network.

Embodiment 35: The method of any of the previous embodiments, further comprising: providing user data; and forwarding the user data to a host via the transmission to the network node.

### Group B Embodiments

Embodiment 36: A method performed by a network node for determining the quality of a serving link, the method comprising one or more of: a. transmitting (Step 1) configuration of a plurality of Downlink, DL, reference signals which represent a plurality of candidate links; b. transmitting (Step 2) a command to activate a subset of the configured plurality of DL reference signals; c. transmitting (Step 3) beam indication where a first DL reference signal is used as the Quasi-Colocation, QCL, source for the physical downlink control channel, PDCCH, and/or the Physical Data Shared Channel, PDSCH, demodulation reference signal, DMRS, of the serving link; d. receiving (Step 8) event-triggered beam report; and e. transmitting (Step 9) beam update where the DL reference signal corresponding to the candidate link with the best quality is updated as the QCL source of the PDCCH and/or the PDSCH DMRS of the serving link.

Embodiment 37: The method of embodiment 1 wherein the configuration is received via Radio Resource Control, RRC.

Embodiment 38: The method of any of the previous embodiments wherein the command is a Medium Access Control, MAC, Control Element, CE, command.

Embodiment 39: The method of any of the previous embodiments wherein the command is to activate a subset of the plurality of candidate links.

Embodiment 40: The method of any of the previous embodiments wherein measuring quality of a plurality or subset of candidate links comprises measuring on RRC configured and/or activated DL reference signals associated with candidate links.

Embodiment 41: The method of any of the previous embodiments wherein the event-triggered beam report comprises the candidate link with the best quality, the associated DL reference signal, and/or measured quantity.

Embodiment 42: The method of any of the previous embodiments wherein the serving link corresponds to the serving cell, wherein calculating the quality of the serving link comprises calculating the quality of a serving cell.

Embodiment 43: The method of any of the previous embodiments wherein deriving the quality of the serving cell, such as the PCell or an SCell of a cell group comprises determining one or more of: Reference signal received power, RSRP; Reference Signal Received Quality, RSRQ; and Signal to interference plus noise ratio, SINR.

Embodiment 44: The method of any of the previous embodiments wherein the serving link corresponds to the serving beam, wherein calculating the quality of the serving link comprises calculating the quality of a serving beam (or RSs transmitted in that beam).

Embodiment 45: The method of any of the previous embodiments wherein the beam is the beam in which the network is transmitting control and data channels to the UE.

Embodiment 46: The method of any of the previous embodiments wherein the quality of the serving link is determined by the QCL source of the PDCCH or the PDSCH DMRS of the serving link.

Embodiment 47: The method of any of the previous embodiments wherein the QCL source of the PDCCH or PDSCH DMRS is a DL reference signal (the DL reference signal can be for example, an SSB, a DMRS, or a CSI-RS).

Embodiment 48: The method of any of the previous embodiments wherein the UE considers the serving link quality as the quality of a reference signal which is transmitted in a spatial direction (beam) which is also transmitting the control channel and/or data channel the UE is monitoring for receiving control information and/or data.

Embodiment 49: The method of any of the previous embodiments wherein the UE derives the cell quality of a serving cell by selecting one or more Reference Signals which is/are a transmitted in spatial directions (beams) which is also transmitting the control channel and/or data channel the UE is monitoring for receiving control information and/or data.

Embodiment 50: The method of any of the previous embodiments wherein determines the beams to be selected for deriving cell quality based on the configuration of the control and/or data channels and the current “state”, wherein the “state” comprises the current active beam transmitting the control and/or data channels.

Embodiment 51: The method of any of the previous embodiments wherein the QCL source of the PDCCH or PDSCH DMRS is provided (configured) in one or more TCI states.

Embodiment 52: The method of any of the previous embodiments wherein the UE updates the serving link quality when it receives an indication of activating and/or deactivating a TCI state (and/or a change of activated TCI state).

Embodiment 53: The method of any of the previous embodiments wherein the UE updates the serving link quality when it receives an indication of activating a TCI state (addition of an active TCI state).

Embodiment 54: The method of any of the previous embodiments wherein a candidate link is represented by a candidate DL reference signal. The DL reference signal can be for example, an SSB or a CSI-RS.

Embodiment 55: The method of any of the previous embodiments wherein the set of DL reference signals representing the candidate links is configured using RRC.

Embodiment 56: The method of any of the previous embodiments wherein the set of DL reference signals representing the candidate links is configured using RRC, and MAC CE is used to activate a subset of them.

Embodiment 57: The method of any of the previous embodiments wherein the DL reference signals representing candidate links are also given as QCL sources in TCI states (i.e., TCI states different from the TCI state that provides the QCL source of the PDCCH or PDSCH DMRS corresponding to the serving link).

Embodiment 58: The method of any of the previous embodiments wherein the same measurement quantity is used for the serving link and the candidate links.

Embodiment 59: The method of any of the previous embodiments wherein the event-driven beam report is triggered when the quality of the serving link becomes worse than the candidate link with the best quality.

Embodiment 60: The method of any of the previous embodiments wherein the event-driven beam report is triggered when the quality of the serving link becomes an offset-worse than the candidate link with the best quality (i.e., quality of the serving link is worse than the quality of the candidate link with best quality minus a predefined/preconfigured offset value).

Embodiment 61: The method of any of the previous embodiments wherein the UE may transmit an event-driven beam report when the serving link becomes worse or offset-worse than at least one of the candidate links being measured by the UE.

Embodiment 62: The method of any of the previous embodiments wherein the triggered report is sent over MAC.

Embodiment 63: The method of any of the previous embodiments wherein the MAC CE may include information regarding the one or multiple candidate links (e.g., identifier(s) of DL reference signal(s) and/or the measured quality values.

Embodiment 64: The method of any of the previous embodiments wherein the report is sent over L1 e.g., as a CSI report over PUCCH and/or PUSCH.

Embodiment 65: The method of any of the previous embodiments wherein the UE may have multiple TCI states simultaneously activated e.g., TCI state-1, . . . , TCI state-K, implying that the UE may then receive PDCCH and/or PDSCH using any of these TCI states.

Embodiment 66: The method of any of the previous embodiments wherein the UE calculates the serving link quality as the strongest quality among the qualities of the RSs used as QCL source of the activated TCIs.

Embodiment 67: The method of any of the previous embodiments wherein the UE calculates the serving link quality as the average quality among the qualities of the RSs used as QCL source of the activated TCIs.

Embodiment 68: The method of any of the previous embodiments wherein the UE calculates the serving link quality as the average quality among the qualities of the RSs used as QCL source of the activated TCIs which are above a determined threshold.

Embodiment 69: The method of any of the previous embodiments wherein the network node operates in a Fifth Generation, 5G, communications network.

Embodiment 70: The method of any of the previous embodiments, further comprising: obtaining user data; and forwarding the user data to a host or a user equipment.

### Group C Embodiments

Embodiment 71: A user equipment for calculating the quality of its serving link, comprising: processing circuitry configured to perform any of the steps of any of the Group A embodiments; and power supply circuitry configured to supply power to the processing circuitry.

Embodiment 72: A network node for determining the quality of a serving link, the network node comprising: processing circuitry configured to perform any of the steps of any of the Group B embodiments; power supply circuitry configured to supply power to the processing circuitry.

Embodiment 73: A user equipment (UE) for calculating the quality of its serving links, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 74: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 75: The host of the previous embodiment, wherein the cellular network further includes a network node configured to communicate with the UE to transmit the user data to the UE from the host.

Embodiment 76: The host of the previous 2 embodiments, wherein: the processing circuitry of the host is configured to execute a host application, thereby providing the user data; and the host application is configured to interact with a client application executing on the UE, the client application being associated with the host application.

Embodiment 77: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 78: The method of the previous embodiment, further comprising: at the host, executing a host application associated with a client application executing on the UE to receive the user data from the UE.

Embodiment 79: The method of the previous embodiment, further comprising: at the host, transmitting input data to the client application executing on the UE, the input data being provided by executing the host application, wherein the user data is provided by the client application in response to the input data from the host application.

Embodiment 80: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 81: The host of the previous embodiment, wherein the cellular network further includes a network node configured to communicate with the UE to transmit the user data from the UE to the host.

Embodiment 82: The host of the previous 2 embodiments, wherein: the processing circuitry of the host is configured to execute a host application, thereby providing the user data; and the host application is configured to interact with a client application executing on the UE, the client application being associated with the host application.

Embodiment 83: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 84: The method of the previous embodiment, further comprising: at the host, executing a host application associated with a client application executing on the UE to receive the user data from the UE.

Embodiment 85: The method of the previous embodiment, further comprising: at the host, transmitting input data to the client application executing on the UE, the input data being provided by executing the host application, wherein the user data is provided by the client application in response to the input data from the host application.

Embodiment 86: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 87: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 88: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 89: The method of the previous embodiment, further comprising, at the network node, transmitting the user data provided by the host for the UE.

Embodiment 90: The method of any of the previous 2 embodiments, wherein the user data is provided at the host by executing a host application that interacts with a client application executing on the UE, the client application being associated with the host application.

Embodiment 91: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 92: The communication system of the previous embodiment, further comprising: the network node; and/or the user equipment.

Embodiment 93: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 94: The host of the previous 2 embodiments, wherein: the processing circuitry of the host is configured to execute a host application, thereby providing the user data; and the host application is configured to interact with a client application executing on the UE, the client application being associated with the host application.

Embodiment 95: The host of the any of the previous 2 embodiments, wherein the initiating receipt of the user data comprises requesting the user data.

Embodiment 96: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 97: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for calculating the quality of its serving link, the method comprising:
receiving a configuration of a plurality of Downlink, DL, reference signals which represent a plurality of candidate links;
receiving a beam indication where a first DL reference signal is used as the Quasi-Colocation, QCL, source for the physical downlink control channel, PDCCH, and/or the Physical Data Shared Channel, PDSCH, demodulation reference signal, DMRS, of the serving link;
measuring a quality of the serving link via measuring on the QCL source of the PDCCH and/or the PDSCH DMRS of the serving link;
measuring a quality of one or more of the plurality of candidate links; and
in response to determining that the quality of the serving link is worse than the quality of the one or more of the plurality of candidate links with best quality:
transmitting an event-triggered beam report.

2. The method of claim 1 further comprising: receiving a beam update where the DL reference signal corresponding to the candidate link with the best quality is updated as the QCL source of the PDCCH and/or the PDSCH DMRS of the serving link.

3. (canceled)

4. The method of claim 1 further comprising: receiving a command to activate a subset of the configured plurality of DL reference signals.

5. (canceled)

6. The method of claim 1 wherein measuring quality of a plurality or subset of candidate links comprises measuring on RRC configured and/or activated DL reference signals associated with candidate links.

7. The method of claim 1 wherein the event-triggered beam report comprises the candidate link with the best quality, the associated DL reference signal, and/or measured quantity.

8. The method of claim 1 wherein the serving link corresponds to the serving cell, wherein calculating the quality of the serving link comprises calculating the quality of a serving cell.

9. The method of claim 1 wherein deriving the quality of the serving cell, such as the PCell or an SCell of a cell group comprises determining one or more of: Reference signal received power, RSRP; Reference Signal Received Quality, RSRQ; and Signal to interference plus noise ratio, SINR.

10-14. (canceled)

15. The method of claim 1 wherein the UE considers the serving link quality as the quality of a reference signal which is transmitted in a spatial direction which is also transmitting the control channel and/or data channel the UE is monitoring for receiving control information and/or data.

16. The method of claim 1 wherein the UE derives the cell quality of a serving cell by selecting one or more Reference Signals which is/are a transmitted in spatial directions which is also transmitting the control channel and/or data channel the UE is monitoring for receiving control information and/or data.

17. The method of claim 1 wherein determines the beams to be selected for deriving cell quality based on the configuration of the control and/or data channels and the current “state”, wherein the “state” comprises the current active beam transmitting the control and/or data channels.

18-37. (canceled)

38. A method performed by a network node for determining the quality of a serving link, the method comprising:
transmitting a configuration of a plurality of Downlink, DL, reference signals which represent a plurality of candidate links;
transmitting a beam indication where a first DL reference signal is used as the Quasi-Colocation, QCL, source for the physical downlink control channel, PDCCH, and/or the Physical Data Shared Channel, PDSCH, demodulation reference signal, DMRS, of the serving link; and
receiving event-triggered beam report, where the trigger was that the quality of the serving link is worse than the quality of the candidate link with best quality.

39. The method of claim 38 further comprising: transmitting a beam update where the DL reference signal corresponding to the candidate link with the best quality is updated as the QCL source of the PDCCH and/or the PDSCH DMRS of the serving link.

40. The method of claim 38 further comprising: transmitting a command to activate a subset of the configured plurality of DL reference signals.

41-43. (canceled)

44. The method of claim 38 wherein measuring quality of a plurality or subset of candidate links comprises measuring on RRC configured and/or activated DL reference signals associated with candidate links.

45. The method of claim 38 wherein the event-triggered beam report comprises the candidate link with the best quality, the associated DL reference signal, and/or measured quantity.

46. The method of claim 38 wherein the serving link corresponds to the serving cell, wherein calculating the quality of the serving link comprises calculating the quality of a serving cell.

47. The method of claim 38 wherein deriving the quality of the serving cell, such as the PCell or an SCell of a cell group comprises determining one or more of: Reference signal received power, RSRP; Reference Signal Received Quality, RSRQ; and Signal to interference plus noise ratio, SINR.

48-75. (canceled)

76. A User Equipment, UE, for calculating the quality of its serving link, the UE comprising processing circuitry and memory, the memory comprising instructions to cause the UE to:
receive a configuration of a plurality of Downlink, DL, reference signals which represent a plurality of candidate links;
receive a beam indication where a first DL reference signal is used as the Quasi-Colocation, QCL, source for the physical downlink control channel, PDCCH, and/or the Physical Data Shared Channel, PDSCH, demodulation reference signal, DMRS, of the serving link;
measure a quality of the serving link via measuring on the QCL source of the PDCCH and/or the PDSCH DMRS of the serving link;
measure a quality of one or more of the plurality of candidate links;
in response to determining that the quality of the serving link is worse than the quality of the one or more of the plurality of candidate links with best quality:
transmit an event-triggered beam report; and
receive a beam update where the DL reference signal corresponding to the candidate link with the best quality is updated as the QCL source of the PDCCH and/or the PDSCH DMRS of the serving link.

77. (canceled)

78. A network node for determining the quality of a serving link, the network node comprising processing circuitry and memory, the memory comprising instructions to cause the network node to:
transmit a configuration of a plurality of Downlink, DL, reference signals which represent a plurality of candidate links;
transmit a beam indication where a first DL reference signal is used as the Quasi-Colocation, QCL, source for the physical downlink control channel, PDCCH, and/or the Physical Data Shared Channel, PDSCH, demodulation reference signal, DMRS, of the serving link;
receive event-triggered beam report, where the trigger was that the quality of the serving link is worse than the quality of the candidate link with best quality; and
transmit a beam update where the DL reference signal corresponding to the candidate link with the best quality is updated as the QCL source of the PDCCH and/or the PDSCH DMRS of the serving link.

79-81. (canceled)
